(19) United States
(12) Patent Application Publication
(10) Pub. No.: US 2015/0179149 A1
(43) Pub. Date: Jun. 25, 2015

(54) DYNAMIC GPU & VIDEO RESOLUTION CONTROL USING THE RETINA PERCEPTION MODEL

(71) Applicant: QUALCOMM Incorporated, San Diego, CA (US)

(72) Inventor: Hee-Jun PARK, San Diego, CA (US)

(73) Assignee: QUALCOMM Incorporated, San Diego, CA (US)

(21) Appl. No.: 14/137,982

(22) Filed: Dec. 20, 2013

(51) Int. Cl. G09G 5/391; G09G 5/00; G06F 3/01; H04B 1/3827

(52) U.S. Cl. CPC G09G 5/391; H04B 1/3833; G09G 5/006; G06F 3/013; G09G 2340/0407

(57) ABSTRACT

A method and an apparatus are provided. The apparatus may be a UE. The UE determines a viewing distance between a display and a user, and determines a minimum resolution based on the viewing distance. In addition, the UE determines to reduce power consumption in the UE. Furthermore, the UE sets a resolution of graphics rendering or video decoding for display on the display to the minimum resolution upon determining to reduce the power consumption in the UE. The minimum resolution and a resolution greater than the minimum resolution may be indistinguishable to at least one eye of the user. The distance between the display and the user may be measured using a camera, an ultrasound sensor, an ultrasonic sensor, or a short-range distance sensor. The UE may apply at least one adjustment factor to enhance or degrade the minimum resolution.

### BACKGROUND

1. Field

The present disclosure relates generally to mobile devices, and more particularly, to dynamic resolution control using a retina perception model.

2. Background

Mobile devices typically have limited battery power and limited capability for thermal dissipation. Conserving such limited battery power and controlling the operating temperature of mobile devices with such limited thermal dissipation capability present difficult challenges, especially in high performance mobile devices, such as smartphones and tablet devices. For example, the display resolution of mobile devices are increasing to support high resolution content (e.g., high definition (HD) movies, games, and/or other multimedia content), which demands increased processing power from the graphics processing unit (GPU) of the mobile devices, the video decoder of the mobile devices, and/or memory access traffic. Such increased processing power may quickly deplete the battery of the mobile devices and may undesirably increase the temperature of the mobile devices.

### SUMMARY

In an aspect of the disclosure, a method and an apparatus are provided. The apparatus may be a mobile device (also referred to as a user equipment (UE)). The UE may determine a viewing distance between a display and a user, and determine a minimum resolution based on the viewing distance. In addition, the UE may determine to reduce power consumption in the UE, and set the resolution of graphics rendering or video decoding for display on the display to the minimum resolution upon determining to reduce the power consumption in the UE.

### BRIEF DESCRIPTION OF THE DRAWINGS

FIG. 1 is a diagram illustrating an example configuration of a mobile device and a user of the mobile device.

FIG. 2 is a diagram illustrating an example of a vision test administered by the mobile device.

FIG. 3 is a diagram illustrating an example of resolution scaling.

FIG. 4 is a diagram illustrating an example of various components of the mobile device.

FIG. 5 is a flow chart illustrating a method of controlling a display resolution.

FIG. 6 is a conceptual flow diagram illustrating the operation of different modules/means/components in an exemplary apparatus.

FIG. 7 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of dynamic resolution control using a retina perception model will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

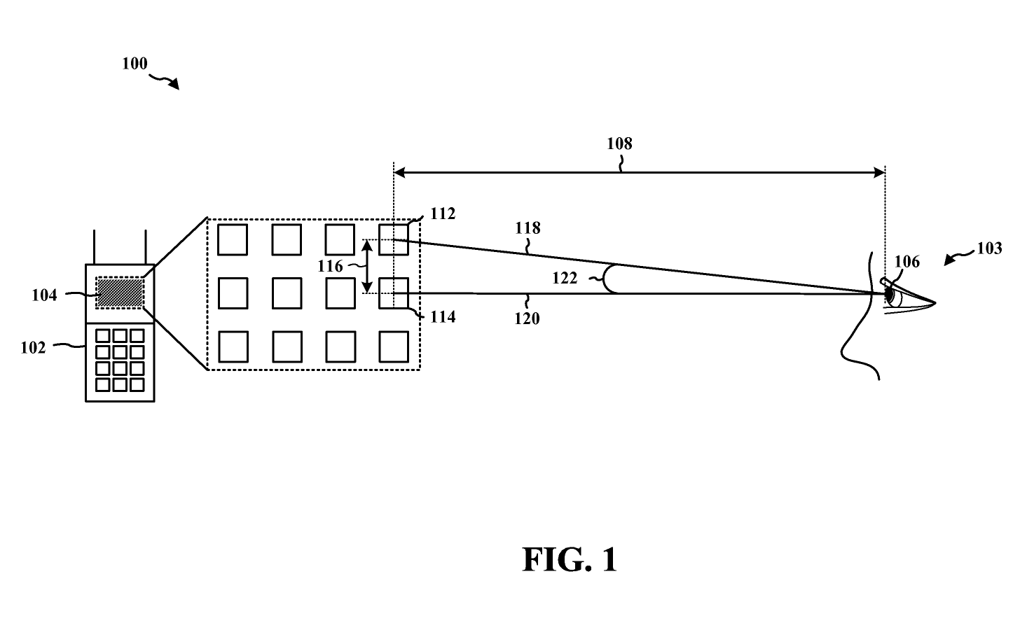

FIG. 1 is a diagram 100 illustrating an example configuration of a mobile device 102 (also referred to as a user equipment (UE)) and a user 103 of the mobile device 102. Examples of a mobile device 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The mobile device 102 may also be referred to by those skilled in the art as a mobile station, a subscriber station, a mobile unit, a subscriber unit, a wireless unit, a remote unit, a wireless device, a wireless communications device, a remote device, a mobile subscriber station, an access terminal, a mobile terminal, a wireless terminal, a remote terminal, a handset, a user agent, a mobile client, a client, or some other suitable terminology.

As shown in FIG. 1, the mobile device 102 has a display 104. In an aspect, the display 104 may be a liquid crystal display (LCD) or an organic light emitting diode (OLED) display having a fixed resolution (e.g., 768×1024). As further shown in FIG. 1, the display 104 is located a distance 108 away from the eye 106 of the user 103. The distance 108 may also be referred to as a viewing distance. For ease of illustration, the display 104 in FIG. 1 is depicted as having twelve pixels (e.g., pixels 112, 114). However, one of ordinary skill in the art will appreciate that the display 104 may have as many as millions of pixels without deviating from the scope of the present disclosure. As shown in FIG. 1, pixel 112 is spaced apart from pixel 114 by a distance 116 (also referred to as pixel spacing). As shown in FIG. 1, a viewing angle 122 formed between the user 103 and two pixels (e.g., pixels 112 and 114) of the display 104. In the configuration of FIG. 1, the viewing angle 122 (also referred to as the visual angle or visual acuity) is formed between the sight line 118 and the sight line 120, where the sight line 118 extends from the eye 106 to the center of pixel 112, and the sight line 120 extends from the eye 106 to the center of pixel 114.

In an aspect, the mobile device 102 may determine a minimum resolution (e.g., minimum pixels per inch (PPI_{RETINA})) for displaying content on the display 104 based on at least the distance 108 between the display 104 and the eye 106 of the user 103. In an aspect, the minimum resolution is a resolution required for the retina perception of the user 103, such that the user 103 does not perceive any significant degradation of the content displayed on the display 104. In an aspect, the minimum resolution is a resolution of the display 104 where at least one eye 106 of the user 103 cannot distinguish between the minimum resolution and a resolution greater than the minimum resolution.

In an aspect, the mobile device 102 may determine the PPI_{RETINA} by applying equation (1):

$${PPI}_{RETINA} = \frac{1}{2 * d * tan ( a / 2 )} \qquad ( equation 1 )$$

where d represents the viewing distance 108 between the eye 106 of the user 103 and the display 104 of the mobile device 102, and a represents the viewing angle 122. In an aspect, the value of a may indicate the visual acuity of the user 103.

In an aspect, the value of d (e.g., viewing distance 108) may be determined by the mobile device 102. For example, the mobile device 102 may use a camera, an ultrasound sensor, an ultrasonic sensor, and/or a short-range distance sensor of the mobile device 102 to determine the viewing distance 108 between the display 104 and the eye 106 of the user 103. In an aspect, the mobile device 102 may determine the value of a by applying equation (2):

tan(a/2)=s/2d (equation 2)

where s represents the distance 116 between adjacent pixels 112 and 114, d represents the viewing distance 108 between the eye 106 of the user 103 and the display 104 of the mobile device 102, and a represents the viewing angle 122. In an aspect, the value of s may be known based on specifications used to manufacture the display 104. For example, the value of s may be stored in a memory of the mobile device 102 and retrieved by the processor of the mobile device 102. Therefore, by determining the values of s and d, the value of a may be determined using equation 2. For example, the value of a may be 1 arcminute ( 1/60^{th} of a degree) for most users with 20/20 vision. It should be understood that equation 2 provides one approach for determining the visual acuity of the user 103 and that the visual acuity of the user 103 may be determined using a different approach in other aspects. In an aspect, based on the visual acuity of the user 103, the value of a may be higher or lower than the value of a determined by applying equation 2. In such an aspect, the mobile device 102 may administer a vision test to the user 103 to determine the value of a.

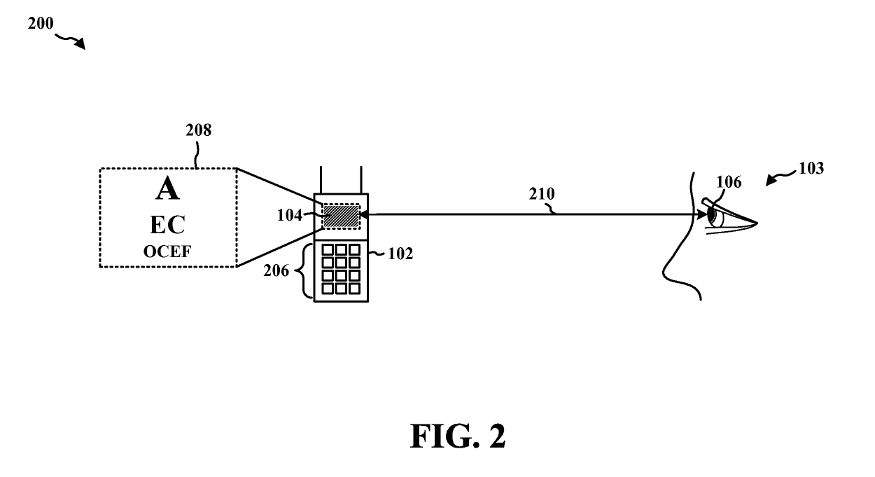

FIG. 2 is a diagram 200 illustrating an example of a vision test administered by the mobile device 102. The vision test may instruct the user 103 to hold the mobile device 102 at a particular viewing distance 210, where the viewing distance 210 extends between the display 104 of the mobile device 102 and the eye 106 of the user 103. In an aspect, the viewing distance 210 is approximately the same as the viewing distance 108 in FIG. 1. For example, this viewing distance 210 may be an arm's length of the user 103. In an aspect, the vision test may display one or more characters 208 on the display 104. In an aspect, the characters 208 may have different sizes and/or different spacing. In another aspect, the vision test may display one or more images, shapes, patterns, numbers, and/or letters, or any combination thereof. The user may provide an input via an input source 206 (e.g., buttons or keys) of the mobile device 102 corresponding to displayed characters 208. The vision test may then determine the value of a (e.g., the visual acuity) of the user 103 based on the accuracy of the inputs provided by the user 103.

In an aspect, the mobile device 102 may determine an adjusted minimum pixels per inch (PPI_{GPU/VIDEO}) for a graphics processing unit (GPU) and/or a video decoder of the mobile device 102 by applying equation (3):

PPI_{GPU/VIDEO}=(PPI_{RETINA})*(r₁)*(r₂) (equation 3)

where PPI_{RETINA} represents the minimum pixels per inch defined by equation 2, and r₁ and r₂ represent adjustment factors. In an aspect, the value of r₁ and the value of r₂ may each be a ratio or percentage applied to the PPI_{RETINA} to enhance or degrade the minimum resolution. In an aspect, the value of r₁ and the value of r₂ may each be input by the user 103. In an aspect, the value of r₁ may be determined depending on the visual acuity of the user 103.

In an aspect, the value of r₁ may be determined from the vision test administered by the mobile device 102 as described supra. For example, for a user having 20/20 vision, the value of r₁ may be 1. In such example, 100% of the PPI_{RETINA} is required for retina perception. As another example, for a user having 20/23 vision (which indicates a user having less than 20/20 vision), the value of r₁ may be 0.9. In such example, 90% of the PPI_{RETINA} is required for retina perception. Alternatively stated, the resolution of content to be displayed on the display 104 is reduced (e.g., degraded) by a factor of 10%, which may result in a reduction of processing workload/power in the mobile device 102.

A user that has better-than-average visual acuity may perceive increases in display resolution even though another user having average visual acuity may not perceive such increases in display resolution. Accordingly, for a user that has better-than-average visual acuity, the adjustment factor r₁ may have a value greater than one (e.g., r₁>1) such that the minimum resolution is enhanced to provide that particular user with higher display resolution. In comparison, a different user may have worse-than-average visual acuity. A user that has worse-than-average visual acuity may not perceive decreases in display resolution even though another user having average visual acuity may perceive such decreases in display resolution. Accordingly, for a user that has worse-than-average visual acuity, the adjustment factor r₁ may have a value lower than one (e.g., r₁<1) such that the minimum resolution is degraded to provide that particular user with lower display resolution.

In an aspect, the value of r₂ may indicate additional display resolution enhancement or degradation. In one aspect, the value of r₂ may be set by the user. For example, a user that prefers longer battery life at the expense of display resolution may set the value of r₂ to a value lower than one (e.g., r₂<1). Accordingly, in such example, the battery life may be conserved by intentionally reducing the display resolution. In another aspect, the value of r₂ may be set by the mobile device 102 based on the remaining battery power and/or temperature of the mobile device 102. For example, an algorithm performed by the mobile device 102 may reduce the value of r₂ when the remaining battery power falls below a first threshold value and/or the temperature of the mobile device 102 rises above a second threshold value.

In an aspect, the mobile device 102 may set the resolution of the graphics rendering and/or the video decoding of the mobile device 102 to the minimum display resolution (e.g., PPI_{RETINA}) as described supra when a reduction in power consumption is desired. In an aspect, the mobile device 102 may determine to reduce power consumption in order to conserve battery power when the remaining battery power of the mobile device 102 is less a first threshold and/or a system temperature of the mobile device 102 is greater than a second threshold.

In an aspect, the mobile device 102 may determine the resolution (Resolution_{GPU/VIDEO}) of the GPU and/or video decoder of the mobile device 102 by applying equation (4):

Resolution_{GPU/VIDEO}=(PPI_{GPU/VIDEO}*l_{H},PPI_{GPU/VIDEO}*l_{V}) (equation 4)

where l_{H} represents the horizontal dimension of the display 104 and l_{V} represents the vertical dimension of the display 104. For example, l_{H} and l_{V} may be represented in inches.

Therefore, by dynamically setting the resolution of content to be displayed on the display 104 to a minimum resolution based on at least the viewing distance, the GPU and/or video decoder of the mobile device 102 may require less processing power. Therefore, the mobile device 102 may reduce power consumption and, consequently, the system temperature of the mobile device 102 may be maintained or reduced. It should be understood that the minimum resolution causes minimal or no perceivable degradation of a user's experience with respect to viewing content on the display 104.

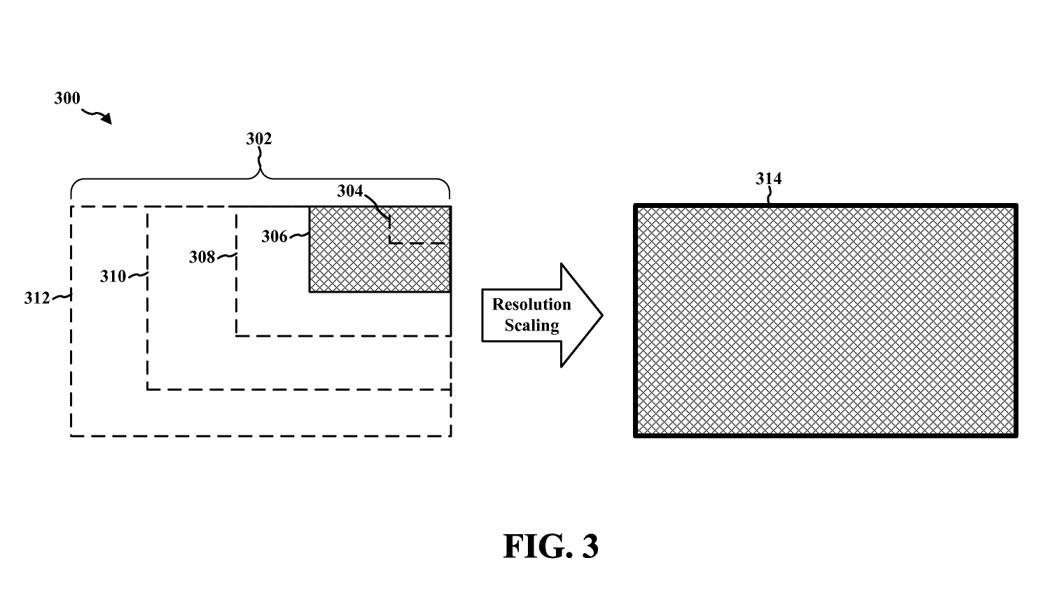

FIG. 3 is a diagram 300 illustrating an example of resolution scaling. In an aspect, the mobile device 102 may scale the resolution of content (e.g., an image or a video) to be displayed on the display 104 in order to accommodate the native resolution of the display 104. In such aspect, a mobile display processor (MDP) of the mobile device 102 may scale the Resolution_{GPU/VIDEO} such that the Resolution_{GPU/VIDEO} conforms to the native resolution of the screen (Resolution_{SCREEN}). The native resolution may be defined as the fixed resolution of a display, such as the display 104. For example, the GPU and/or the video decoder of the mobile device 102 may support one or more processing resolutions 302, such as resolutions 304, 306, 308, 310 and 312. The GPU and/or the video decoder of the mobile device 102 may process content to be displayed on the display 104 based on the Resolution_{GPU/VIDEO}. For example, the Resolution_{GPU/VIDEO} may correspond to the resolution 306 in FIG. 3. The MDP of the mobile device 102 may scale the resolution 306 to accommodate the native resolution 314 of the display 104. In an aspect, the mobile device 102 may scale the Resolution_{GPU/VIDEO} by increasing or decreasing the size of the content to be displayed on the display 104. For example, the size of the content may be increased by inserting pixels in the content and may be decreased by removing pixels from the content.

In an aspect, with reference to FIG. 3, the mobile device 102 may set the output resolution of the GPU and/or the video decoding of the mobile device 102 to the Resolution_{GPU/VIDEO}. For example, an image output by the GPU and/or the video decoding of the mobile device 102 may have been scaled by a factor of 1/x to produce the image having the minimum resolution 306. However, the mobile device 102 may scale the image having the minimum resolution 306 by a factor of x to generate the image having the resolution 314.

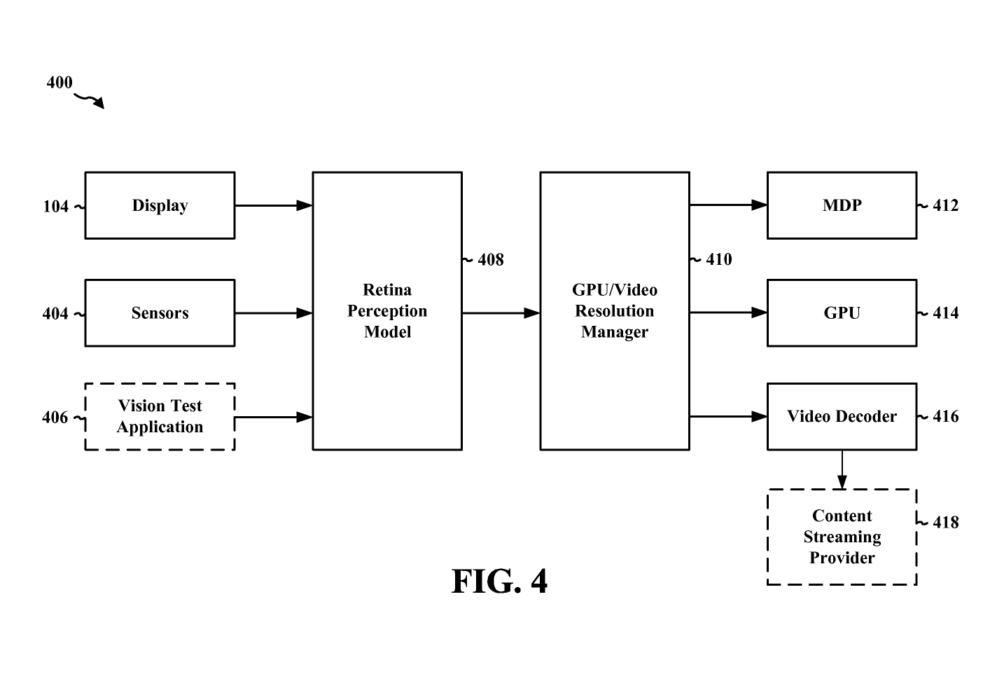

FIG. 4 is a diagram 400 illustrating an example of various components of the mobile device 102. In an aspect, the retina perception model 408 may be configured to determine the minimum display resolution (e.g., PPI_{RETINA}) for the display 104 based on at least the viewing distance 108. In an aspect, the retina perception model 408 may receive information from the display 104, sensors 404, and/or the vision test application 406 to determine the minimum display resolution. For example, the retina perception model 408 may receive information regarding the hardware native resolution of the display 104, the physical screen size of the display 104, and/or the aspect ratio of the display 104 from the display 104. The retina perception model 408 may further receive information regarding the value of d (e.g., the viewing distance 108) based on real-time sensing. In an aspect, the sensors 404 may include a camera, an ultrasound sensor, an ultrasonic sensor, and/or a short-range distance sensor configured to determine the viewing distance 108. The retina perception model 408 may further receive information from a vision test application 406 regarding the results of a vision test. For example, the information from the vision test application 406 may indicate the visual acuity of the user and may include information regarding the value of a (e.g., the viewing angle 122). It should be understood that the vision test application 406 indicated by dashed lines in FIG. 4 is optional.

The minimum display resolution (e.g., PPI_{RETINA}) for the display 104 output from the retina perception model 408 may be provided to the GPU/video resolution manager 410. In an aspect, the GPU/video resolution manager 410 may apply at least one adjustment factor (e.g., the value r₁ and/or the value r₂) to enhance or degrade the minimum display resolution based on the visual acuity of the user. The resolution output from the GPU/video resolution manager 410 may be provided to the MDP 412, the GPU 414, and/or the video decoder 416.

In an aspect, the MDP 412 may scale the resolution provided by the GPU/video resolution manager 410. In an aspect, the MDP 412 may scale the resolution of content (e.g., an image or a video) to be displayed on the display 104 in order to accommodate the native resolution of the display 104. For example, the MDP 412 may scale the Resolution_{GPU/VIDEO} such that the Resolution_{GPU/VIDEO} conforms to the native resolution of the screen (Resolution_{SCREEN}).

The GPU 414 may be a processor or electronic circuit configured to generate images intended for display on the display 104 based on the resolution from the GPU/video resolution manager 410. For example, the GPU 414 may be used for rendering 3-dimensional (3D) images on the display 104. The video decoder 416 may be a hardware component that is different from the GPU 414. The video decoder 416 may decode encoded video signals and generate videos intended for display on the display 104 based on the resolution from the GPU/video resolution manager 410. For example, the video decoder 416 may be used for rendering videos on the display 104. In an aspect, the video decoder 416 may provide an output to a content streaming provider 418, which may be an Internet-based video broadcasting service (e.g., YouTube™).

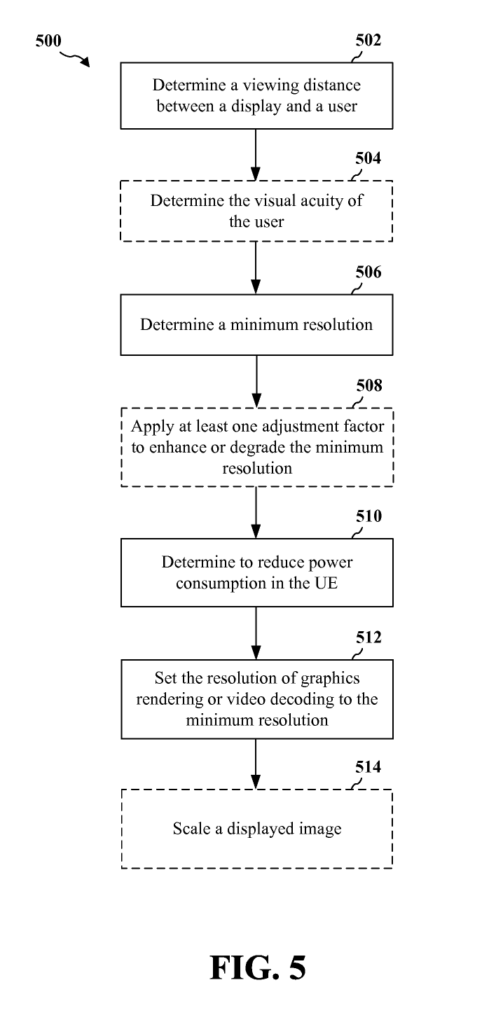

FIG. 5 is a flow chart 500 illustrating a method of controlling a display resolution. The method may be performed by a mobile device, such as the mobile device 102. At step 502, the mobile device determines a viewing distance between a display of the mobile device and a user of the mobile device. For example, with reference to FIG. 1, the mobile device 102 determines the viewing distance 108. In some configurations, the viewing distance 108 (e.g., the value of d) between the display 104 and the eye 106 of the user 103 may be measured using a camera, an ultrasound sensor, an ultrasonic sensor, and/or a short-range distance sensor.

At step 504, the mobile device determines the visual acuity of the user of the mobile device. In an aspect, with reference to FIG. 1, the mobile device 102 may determine the visual acuity of the user 103 based on the viewing angle 122. In such example, the mobile device 102 may determine the value of s (e.g., the distance 116 between adjacent pixels 112 and 114). The mobile device 102 may then use the value of s and the value of d to determine the value of a (e.g., the visual acuity of the user 103) by applying equation 2.

In another aspect, the visual acuity of the user may be determined using a vision test. For example, with reference to FIG. 2, the mobile device 102 may display one or more characters 208 to the user, receive an input from the user indicating one or more identified characters, and determine the visual acuity based on an accuracy of the input from the user. The vision test may instruct the user 103 to hold the mobile device 102 at a particular viewing distance 210, where the viewing distance 210 extends between the mobile device 102 and the eye 106 of the user 103. For example, this viewing distance 210 may be an arm's length of the user 103. In an aspect, the vision test may then display one or more characters 208 on the display 104. In an aspect, the characters 208 may have different sizes and/or different spacing. In another aspect, the vision test may display one or more images, shapes, patterns, numbers, and/or letters, or any combination thereof. The user 103 may provide an input to an input source 206 (e.g., buttons or keys) corresponding to displayed characters 208. The vision test may then determine the value of a (e.g., the visual acuity) of the user 103 based on the accuracy of the inputs provided by the user 103.

At step 506, the mobile device determines a minimum resolution based on the viewing distance. For example, with reference to FIG. 1, the mobile device 102 may determine the minimum pixels per inch (e.g., PPI_{RETINA}) for the user 103 by applying equation 1, where the mobile device 102 may display content on the display 104 according to the minimum pixels per inch. In an aspect, the minimum resolution is a resolution of the display 104 where at least one eye 106 of the user 103 cannot distinguish between the minimum resolution and a resolution greater than the minimum resolution.

At step 508, the mobile device applies at least one adjustment factor to enhance or degrade the minimum resolution. In an aspect, with reference to FIG. 1, the mobile device 102 may adjust the minimum pixels per inch (e.g., PPI_{RETINA}) based on the value of r₁ and/or the value of r₂ to determine an adjusted minimum pixels per inch (e.g., PPI_{GPU/VIDEO}) by applying equation (3). As previously discussed, the values of r₁ and r₂ may be ratios or percentages applied to the PPI_{RETINA} to enhance or degrade the minimum resolution. In an aspect, the values of r₁ and r₂ may be input by the user 103. In an aspect, the value of r₁ may be determined depending on the visual acuity of the user 103. In an aspect, the value of r₁ may be determined from the vision test administered by the mobile device 102 as described supra. In an aspect, the value of r₂ may indicate additional display resolution enhancement or degradation as described supra.

At step 510, the mobile device determines to reduce power consumption. In an aspect, with reference to FIG. 1, the mobile device 102 may determine to reduce power consumption in order to conserve battery power when the remaining battery power of the mobile device 102 is less a first threshold and/or a system temperature of the mobile device 102 is greater than a second threshold.

At step 512, the mobile device sets the resolution of at least one of graphics rendering or video decoding for display on the display to the minimum resolution upon determining to reduce the power consumption in the mobile device.

At step 514, the mobile device scales an image displayed on the display. In an aspect, with reference to FIGS. 1 and 3, the mobile device 102 scales an image by a factor of 1/x. In such aspect, an image having resolution 306 may be scaled by a factor of x to generate the scaled image having resolution 314.

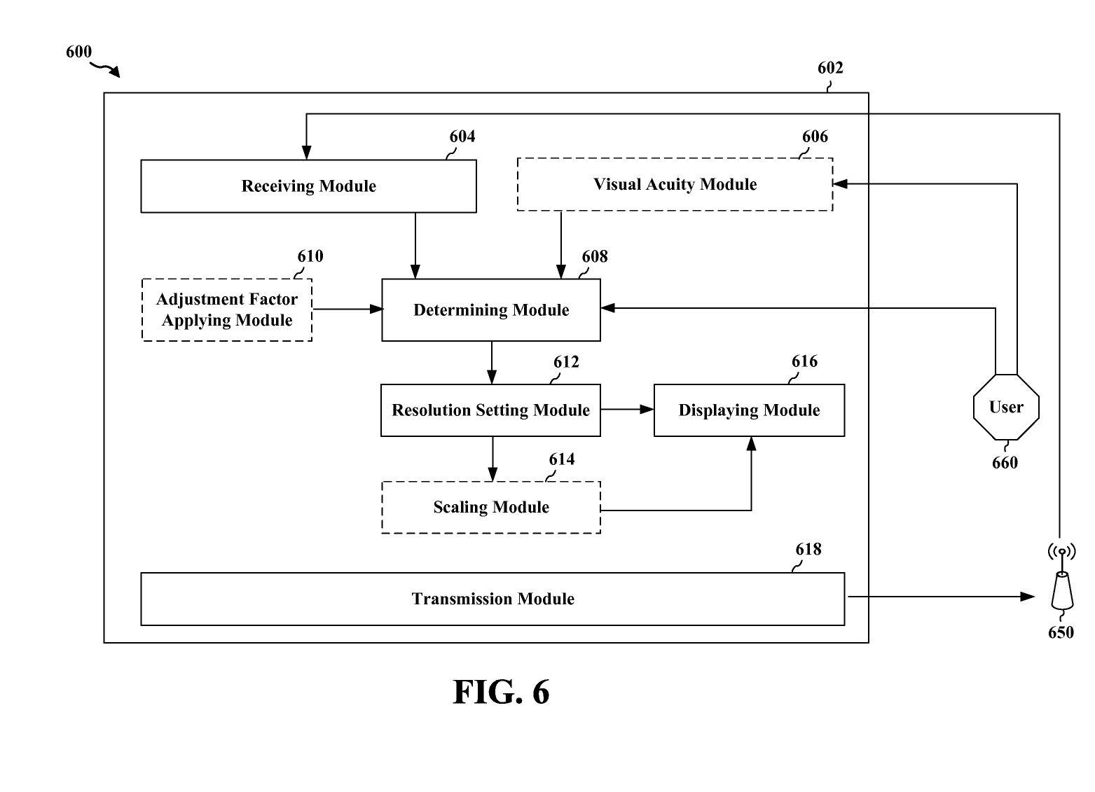

FIG. 6 is a conceptual flow diagram 600 illustrating the operation of different modules/means/components in an exemplary apparatus 602. The apparatus may be a mobile device, such as the mobile device 102. The mobile device includes a module 604 that receives transmissions from a network 650 or from other mobile devices, a module 606 that determines the visual acuity of a user 660, a module 608 that determines a viewing distance between a display and the user 660, determines a minimum resolution based on the viewing distance, and/or determines to reduce power consumption in the mobile device, a module 610 that applies at least one adjustment factor to enhance or degrade the minimum resolution, a module 612 that sets the resolution of at least one of graphics rendering or video decoding for display on the display to the minimum resolution upon determining to reduce the power consumption in the mobile device, a module 614 that scales a displayed image by a factor of x, wherein a factor of 1/x was applied to obtain the minimum resolution, a module 616 that displays content based on the minimum resolution, a module 618 that sends transmissions to the network 650 or to other mobile devices.

The apparatus may include additional modules that perform each of the steps in the aforementioned flow chart of FIG. 5. As such, each step in the aforementioned flow chart of FIG. 5 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

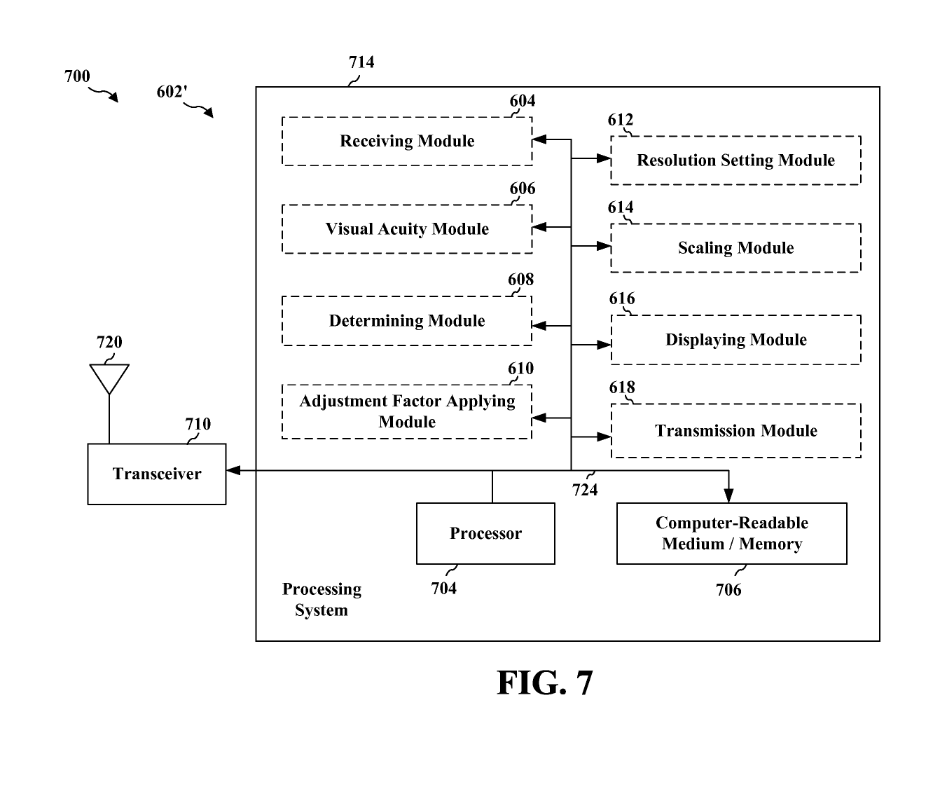

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 704, the modules 604, 606, 608, 610, 612, 614, 616, and 618, and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 720. The transceiver 710 provides a means for communicating with various other apparatus over a transmission medium. The transceiver 710 receives a signal from the one or more antennas 720, extracts information from the received signal, and provides the extracted information to the processing system 714, specifically the receiving module 604. In addition, the transceiver 710 receives information from the processing system 714, specifically the transmission module 618, and based on the received information, generates a signal to be applied to the one or more antennas 720. The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system further includes at least one of the modules 604, 606, 608, 610, 612, 614, 616, and 618. The modules may be software modules running in the processor 704, resident/stored in the computer readable medium/memory 706, one or more hardware modules coupled to the processor 704, or some combination thereof.

In one configuration, the apparatus 602/602′ for wireless communication may include means for determining a viewing distance between a display and a user, means for determining a minimum resolution based on the viewing distance, means for determining to reduce power consumption in the UE, means for setting the resolution of at least one of graphics rendering or video decoding for display on the display to the minimum resolution upon determining to reduce the power consumption in the UE, and means for determining a visual acuity of the user. The minimum resolution and a resolution greater than the minimum resolution may be indistinguishable to at least one eye of the user. The apparatus may further include means for applying at least one adjustment factor to enhance or degrade the minimum resolution. The aforementioned means may be one or more of the aforementioned modules of the apparatus 602 and/or the processing system 714 of the apparatus 602′ configured to perform the functions recited by the aforementioned means.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of a user equipment (UE), comprising:
determining a viewing distance between a display and a user;
determining a minimum resolution based on the viewing distance;
determining to reduce power consumption in the UE; and
setting a resolution of at least one of graphics rendering or video decoding for display on the display to the minimum resolution upon determining to reduce the power consumption in the UE.

2. The method of claim 1, wherein the minimum resolution and a resolution greater than the minimum resolution are indistinguishable to at least one eye of the user.

3. The method of claim 1, further comprising:
determining a visual acuity of the user, wherein the determining the minimum resolution is further based on the visual acuity.

4. The method of claim 3, wherein the visual acuity is determined based on a viewing angle, wherein the viewing angle is an angle formed at the user with respect to two adjacent pixels of the display.

5. The method of claim 3, wherein the visual acuity is determined by a vision test performed using the display.

6. The method of claim 5, wherein the vision test comprises:
displaying one or more characters to the user;
receiving an input from the user indicating one or more identified characters; and
determining the visual acuity based on an accuracy of the input from the user.

7. The method of claim 1, wherein the distance between the display and the user is measured using at least one of a camera, an ultrasound sensor, an ultrasonic sensor, and a short-range distance sensor.

8. The method of claim 1, further comprising applying at least one adjustment factor to enhance or degrade the minimum resolution.

9. The method of claim 8, wherein the at least one adjustment factor is input by the user or obtained from results of a vision test.

10. The method of claim 1, further comprising scaling a displayed image by a factor of x, wherein a factor of 1/x was applied to obtain the minimum resolution.

11. The method of claim 1, wherein the power consumption is determined to be reduced when at least one of a remaining battery power is less a first threshold or a system temperature is greater than a second threshold.

12. A user equipment (UE), comprising:
means for determining a viewing distance between a display and a user;
means for determining a minimum resolution based on the viewing distance;
means for determining to reduce power consumption in the UE; and
means for setting a resolution of at least one of graphics rendering or video decoding for display on the display to the minimum resolution upon determining to reduce the power consumption in the UE.

13. The UE of claim 12, wherein the minimum resolution and a resolution greater than the minimum resolution are indistinguishable to at least one eye of the user.

14. The UE of claim 12, further comprising:
means for determining a visual acuity of the user, wherein the determining the minimum resolution is further based on the visual acuity.

15. The UE of claim 14, wherein the visual acuity is determined based on a viewing angle, wherein the viewing angle is an angle formed at the user with respect to two adjacent pixels of the display.

16. The UE of claim 14, wherein the visual acuity is determined by a vision test performed using the display.

17. The UE of claim 12, wherein the distance between the display and the user is measured using at least one of a camera, an ultrasound sensor, an ultrasonic sensor, and a short-range distance sensor.

18. The UE of claim 12, further comprising means for applying at least one adjustment factor to enhance or degrade the minimum resolution.

19. The UE of claim 18, wherein the at least one adjustment factor is input by the user or obtained from results of a vision test.

20. The UE of claim 12, further comprising means for scaling a displayed image by a factor of x, wherein a factor of 1/x was applied to obtain the minimum resolution.

21. The UE of claim 12, wherein the power consumption is determined to be reduced when at least one of a remaining battery power is less a first threshold or a system temperature is greater than a second threshold.

22. A user equipment (UE), comprising:
a memory; and
at least one processor coupled to the memory and configured to:
determine a viewing distance between a display and a user;
determine a minimum resolution based on the viewing distance;
determine to reduce power consumption in the UE; and
set a resolution of at least one of graphics rendering or video decoding for display on the display to the minimum resolution upon determining to reduce the power consumption in the UE.

23. The UE of claim 22, wherein the minimum resolution and a resolution greater than the minimum resolution are indistinguishable to at least one eye of the user.

24. The UE of claim 22, wherein the least one processor is further configured to:
determine a visual acuity of the user, wherein the determining the minimum resolution is further based on the visual acuity.

25. The UE of claim 24, wherein the visual acuity is determined based on a viewing angle, wherein the viewing angle is an angle formed at the user with respect to two adjacent pixels of the display.

26. The UE of claim 22, wherein the distance between the display and the user is measured using at least one of a camera, an ultrasound sensor, an ultrasonic sensor, and a short-range distance sensor.

27. The UE of claim 22, wherein the least one processor is further configured to apply at least one adjustment factor to enhance or degrade the minimum resolution.

28. The UE of claim 22, wherein the least one processor is further configured to scale a displayed image by a factor of x, wherein a factor of 1/x was applied to obtain the minimum resolution.

29. The UE of claim 22, wherein the power consumption is determined to be reduced when at least one of a remaining battery power is less a first threshold or a system temperature is greater than a second threshold.

30. A computer program product, comprising:
a computer-readable medium comprising code for:
determining a viewing distance between a display and a user;
determining a minimum resolution based on the viewing distance;
determining to reduce power consumption in a user equipment (UE); and
setting a resolution of at least one of graphics rendering or video decoding for display on the display to the minimum resolution upon determining to reduce the power consumption in the UE.
